(19) United States
(12) Patent Application Publication
(10) Pub. No.: US 2011/0220143 A1
(43) Pub. Date: Sep. 15, 2011

(54) Device for Treating an Inner Surface of a Work Piece

(75) Inventors: Christian Buske, Steinhagen (DE); Peter Förnsel, Spenge (DE)

(73) Assignee: PlasmaTreat GmbH, Steinhagen (DE)

(21) Appl. No.: 12/988,133

(22) PCT Filed: Apr. 3, 2009
(86) PCT No.: PCT/EP2009/054028

§ 371 Date: May 31, 2011

(30) Foreign Application Priority Data
Apr. 18, 2008 (DE) 102008019750.5
Oct. 17, 2008 (DE) 102008051801.8

(51) Int. Cl. B08B 7/00; B08B 13/00

(52) U.S. Cl. 134/1.1; 156/345.1; 156/345.29; 156/345.33; 156/345.44

(57) ABSTRACT

A device for cleaning an inner surface of a workpiece includes a beam of radiation, at least one generating unit for generating the beam, a drive unit for rotating the at least one generating unit about an axis of rotation, where the at least one generating unit is configured with a preferential direction towards the surface to be treated. So that an inner surface of the workpiece can be cleaned with short effect times of the beam, it is provided that an arm connected to the at least one generating unit is provided for inserting the generating unit into the workpiece and that the axis of rotation and the preferential direction are inclined relative to one another.

### CROSS-REFERENCE TO RELATED APPLICATIONS

This application is a National Phase Application of International Patent Application No. PCT/EP2009/054028, filed on Apr. 3, 2009, which claims the benefit and priority to German Patent Application No. DE 10 2008 019 750.5 filed on Apr. 18, 2008 and German Patent Application No. DE 10 2008 051 801.8 filed on Oct. 17, 2008, which are owned by the assignee of the instant application. The disclosure of each of these applications is incorporated herein by reference in its entirety.

### FIELD OF THE INVENTION

The invention relates to a device for treating an inner surface of a workpiece, with a radiation, with at least one generating unit for generating the radiation, with a drive unit for rotating the at least one generating unit about an axis of rotation, the at least one generating unit for emitting the generated radiation being configured with a preferential direction toward the surface to be treated. The invention also relates to a method for treating an inner surface of a workpiece with a radiation, in particular with a device of this type.

### BACKGROUND

Devices for treating a surface with a plasma radiation or a corona discharge are already known from many applications. However, in these applications outer surfaces in particular are treated. Inner surfaces can also be treated with the known device by applying the known methods. However, the result of the treatment is not satisfactory or the required length of the treatment is disproportionately long.

A device for uniform, intensive corona treatment of workpiece surfaces is known from the prior art, for example from EP 0 497 996 A1. The operating principle is based on the fact that a corona discharge is generated, in a known manner, between two electrodes that are arranged on the same side of the surface to be treated. Via a gas flow directed toward the surface to be treated, in which gas flow the spark channel is formed, the spark channel is eventually deformed toward the surface to be treated in such a way that the spark channel or, respectively, individual sparks strike the surface of the workpiece to be treated. In contrast to even surfaces, the treatment of workpieces with considerable recesses is not possible or is only inadequately possible.

Devices for generating a plasma beam, so called ‘plasma nozzles’, are already known from the prior art. For example, DE 195 32 412 C2 discloses a plasma beam generator comprising a nozzle. An annular electrode is arranged at the nozzle opening. A pin electrode is arranged recessed in the nozzle coaxially from the nozzle opening. An arc discharge is ignited between the pin electrode and the annular electrode by a high-frequency voltage generator. During operation a working gas flows through the plasma nozzle. The working gas is swirled in the plasma nozzle by a swirler. The swirling of the working gas in the nozzle ensures that the arc discharge is guided along the vortex core, coaxially in the nozzle from the pin electrode toward the nozzle opening, where it fans out radially onto the annular electrode. The working gas is excited by the arc discharge to form a plasma beam separated from the arc discharge, which plasma beam is emitted from the nozzle opening with the remaining working gas.

In other devices of this type at least one electrode pair is provided in the side wall of the nozzle to generate a plasma beam. An arc discharge is then set from one side of the nozzle to the other side of the nozzle. The arrangement of the electrodes of an electrode pair and therefore also the arc discharge is oriented transverse to the working gas flowing from the gas inlet to the gas outlet. Neither a pin electrode nor a swirling of the working gas is therefore necessary during flowing through the nozzle. It must merely be ensured that the arc discharge between the two electrodes of the at least one electrode pair is provided in the cross-section through which the working gas flows.

When using a single plasma beam of a plasma nozzle of the aforementioned types, as a result of the small diameter of the plasma beam only a small region of a workpiece can treated at one time, so that the workpiece is generally treated in a stripe-wise manner. In order to treat wider strips of the workpiece surface using a plasma nozzle, where necessary other plasma nozzles are positioned parallel and excentrically to an axis of rotation, so that the rotation of the plasma nozzles practically produces a plasma beam of greater diameter that is directed perpendicularly toward the workpiece surface to be treated. Alternatively, a plurality of plasma nozzles are arranged beside one another in a row. The plasma nozzles can also be arranged beside one another in a plurality of rows, the plasma nozzles of the adjacent rows being arranged offset from one another so as to ensure uniform plasma treatment.

Plasma nozzles and devices for corona treatment of the aforementioned types are used, for example, in plasma pretreatment or, respectively, corona treatment of workpieces, when these are to be coated, lacquered or adhered, so as to remove impurities from the surface and, in particular in workpieces made of plastics material, to change the molecular structure in such a way that the treated surface can be wetted with liquids, such as adhesives, lacquers and the like. Furthermore, an appropriate pretreatment can improve the weldability of electrically conductive workpieces that tend to form a surface layer impeding the welding process. The plasma pretreatment is routinely carried out at low temperatures.

Furthermore, plasma nozzles of the aforementioned types can be used in the plasma coating of workpieces. In plasma coating it is necessary to supply a coating material or, respectively, a precursor material to the plasma. However, additive materials with advantageous effects can also be used in the plasma pretreatment of workpieces. These materials are supplied with the plasma beam to the surface to be processed and exhibit there the desired effect triggered by the plasma energy, for example they are deposited on the surface as a thin layer.

In order to generate the plasma, in the two types of plasma nozzle described above a high-frequency high voltage is applied to the electrodes, which voltage must be so high that a discharge from one electrode to the other electrode can penetrate through the working gas and thus ionize the working gas along the discharge path. Usually, a discharge path is thereby generally chosen in a way that a working gas flowing at a specific velocity is ionized by the discharge long enough to achieve a desired plasma intensity.

By using the plasma nozzles of the aforementioned types, planar workpieces can be treated readily, the plasma beam being directed perpendicularly toward the surface to be treated of the workpiece. However, if a workpiece comprises larger recesses, the inner surface of these recesses cannot be reached suitably, even when using the plasma nozzles arranged in rows. This can be compensated for, in part, by longer exposure times of the plasma beam, but this results in low output.

The devices for corona treatment are also operated with an alternating voltage. The voltage thereby is sufficiently high to generate the field strengths necessary for corona discharge. The sparks produced with the corona discharge or, respectively, the ionized radiation thereby produced can be readily directed toward an even or uneven surface using the known devices. However, the inner surface of a workpiece is not treated or is, at best, treated inadequately.

### SUMMARY OF THE INVENTION

The technical problem underlying the present invention is therefore to propose a device and a method of the aforementioned type, with which an inner surface of a workpiece can also be processed with short exposure times to the radiation.

This technical problem is solved with a device of the type mentioned at the outset (i.e., a device with at least one generating unit for generating radiation, with a drive unit for rotating the at least one generating unit about an axis of rotation, the at least one generating unit for emitting the generated radiation being configured with a preferential direction toward the surface to be treated) in that an arm connected to the at least one generating unit is provided for inserting the generating unit into the workpiece, and in that the axis of rotation and the preferential direction are inclined relative to one another.

The technical problem is also solved by a method of the type mentioned at the outset, in which at least one generating unit connected to an arm is inserted into the workpiece at the arm, in which the at least one generating unit is rotated by a drive unit about an axis of rotation, in which the at least one generating unit emits the radiation onto the surface in a preferential direction inclined relative to the axis of rotation.

In particular, an arm for inserting the generating unit into an opening of the workpiece is narrow compared to the nozzle unit and approximately rod-shaped. However, in principle other configurations of the arm are also possible. The arm can therefore also be configured as a projection, in particular in the form of a protrusion of the generating unit. In any case the arm is configured in such a way that it makes it possible to insert the generating unit into the opening of the workpiece.

Within the context of the invention an inner surface is to be understood, quite generally, to be the surface in recesses of the workpiece. Recesses are not understood to be mere unevennesses in the workpiece surface, but surfaces that are offset in the interior of the workpiece from the outer surface. In particular, the surfaces formed by openings, bores, holes, blind holes, blind bores and undercuts are possible examples, in particular the inner surfaces of a cylinder of an internal combustion engine, for example for motor vehicles such as cars. The opening of the workpiece can preferably be considered as a border between the inner and the outer surface. If an opening is not also formed by the recess, the recess also does not form an inner surface. In this instance the surface of the recess is part of the outer surface of the workpiece.

The invention has thus identified that the critical inner surfaces can be treated better by the device according to the invention if the device comprises an arm with which the generating unit of the radiation can be placed not only in the vicinity of the workpiece, but can be inserted into an opening of the workpiece, which opening can be formed by the transition between the outer surface and the inner surface. For example, the device can in any case ‘dip’ into an opening of the workpiece with the generating unit and treat the inner surface present there behind in close proximity using appropriate high-energy radiation. The generating unit is therefore not, as is normal, positioned for example at a distance from the workpiece for generation of corona radiation or plasma radiation and moved relative to the workpiece over the surface thereof.

The generating unit is also rotated about an axis of rotation in order to directly reach a larger part of the inner surface of the workpiece using the high-energy radiation. In particular this is also achieved in that the preferential direction of the generated high-energy radiation is oriented inclined to the axis of rotation. Inner surfaces can thus also be treated intensively with the radiation, which surfaces are considerably inclined relative to the outer surface outside the opening in the surface of the workpiece, for example as is the case in bore holes such as cylinder bores in a motor unit.

Alternatively, the workpiece could of course also be rotated about the device for treating the inner surface, but this is less preferred owing to the higher complexity.

Depending on the application, the angle between the preferential direction and the axis of rotation is preferably 25° to 90°, in particular approximately 45° to 90°. This makes it possible, in many cases, to treat the surface satisfactorily with the radiation, for example in the form of a plasma radiation or an ionized radiation as a result of corona discharge.

In accordance with a further teaching the axis of rotation is arranged in any case substantially at right angles to the preferential direction of the radiation. By using a corresponding device bores or blind holes uncoupled from the outer surface of the workpiece can be processed particularly effectively. For example in this instance the axis of rotation can be parallel to the center line of a bore or a hole, in particular however coincident therewith. In the latter case the treatment of the inner surface is possible in a particularly simple and uniform manner.

In order to treat the inner surfaces, for example of blind bores, uniformly in the wall region and in the base region, it may be expedient for the preferential direction to have an angle of approximately 45° to the axis of rotation of the generating means.

What is particularly expedient, not only for reasons of versatility of the device with regard to the treatment of different workpieces, is if the arm and the at least one generating unit are interconnected in a jointed manner. On the one hand, this makes it possible to adjust the device optimally. On the other hand, the generating unit can thus also be pivoted back and/or forth with relative to the arm, preferably continuously, depending on the workpiece geometry to be taken into consideration. The radiation, for example a plasma radiation or ionized radiation as a result of corona discharge, can thus always be directed substantially perpendicularly toward the surface to be treated irrespective of whether it is an inner or an outer surface or, respectively, whether it is a wall region or a base region of a blind hole. The corresponding surfaces can be treated efficiently to the same extent. The axis of rotation is varied within an angular range, preferably from 0° to 90°, to the preferential direction of the high-energy beam emitted.

The treatment of the inner surface of a blind hole or a blind bore using a single device is therefore also possible. For example, if the base region of a blind hole or a blind bore is to be treated, the preferential direction is oriented parallel to the axis of rotation (angle=0°). Rotation of the at least one generating unit may still be preferred when using a corona discharge. The rotation of the generating unit can, as required, be dispensed with, in particular when using a plasma radiation. The use of a rotation of the at least one generating unit thereby is, for example, dependent on the position of the axis of rotation in relation to the generating unit. In contrast, if the remaining inner surface of the blind hole or blind bore is to be treated beforehand or after, the preferential direction is thus oriented obliquely to the axis of rotation (angle≠0°), in particular at right angles to the axis of rotation (angle=90°).

In order to treat the inner surface of a blind hole or a blind bore using the high-energy radiation, for example plasma radiation or ionized radiation as a result of corona discharge, a two-step method may be used alternatively or additionally. In this method, in a first step for example, the base of the blind hole can be processed using at least a first generating unit. It is not absolutely necessary to use a rotating generating unit for this. It is also not imperatively necessary for this generating unit to be fixed to an arm so as to insert the generating unit into the workpiece through the opening in the blind hole or blind bore, although this may definitely be preferred, in particular in the case of blind bores or blind holes of which the opening cross-section is small compared to the depth of the blind bore or blind hole.

The preferential direction of the at least one, for example first generating unit is oriented substantially perpendicularly to the base of the blind hole or blind bore. The remaining regions of the inner surface of the blind hole or the blind bore are treated, for example, in a prior or subsequent second step using a device that, in contrast to the other device, is configured in accordance with the invention. It is conceivable for the one device to process, in one processing step, the outer surface of the workpiece and to process the inner surface of the workpiece in the region of the base of the blind hole or the blind bore. In the operating mode of the at least one generating unit, when its orientation to the blind hole or blind bore is faded out, it cannot be identified whether a part of the outer or inner surface is being treated.

In a further configuration of the device, a drive unit for rotating the arm about an axis of rotation is provided, said drive unit being an additional drive unit or the drive unit for rotating the generating unit. For example in this instance the generating unit is rotated by rotation of the arm. The axis of rotation of the generating unit and the axis of rotation of the arm will coincide in this instance. However, the two axes can also be arranged at a distance to one another and/or at an angle to one another.

In particular, in order to treat inner surfaces that extend far into the workpiece, a displacement means may be provided that makes it possible to vary the penetration depth of the at least one generating unit during surface treatment. The generating unit is then introduced into the workpiece to be treated and/or removed therefrom step-wise or continuously. In the meantime the inner surface is treated annularly or helically as a result of the rotation of the generating unit. The generating unit therefore does not have to be adapted to the penetration depth in the workpiece, which also improves the versatility both of the device and of the method.

It is also expedient if a suction means is provided for sucking off a gas from a space between the generating unit and the surface to be treated of the workpiece. Materials sticking to the surface to be treated that must be removed can thus be removed via the gas flow. This is particularly preferred with use of corona discharge for surface treatment, since then no gas flow is generated in the generating unit. In any case, a suction can also be provided in addition to a plasma radiation in order to improve the discharge of substances removed from the surface.

In a particularly preferred configuration of the teaching, the inner surface of the workpiece is treated with a plasma radiation in the form of a plasma beam. The plasma beam is generated by a generating unit in the form of a nozzle unit. For this purpose the nozzle unit comprises at least one nozzle interior. The nozzle unit also comprises a gas inlet for the inflow of a working gas into the nozzle interior as well as a gas outlet for the outlet of the working gas in a preferential direction toward the surface of the workpiece. The emitted working gas is thereby changed when it passes through the nozzle interior, in such a way that the working gas flowing out of the gas outlet constitutes the plasma beam. In this configuration of the teaching the nozzle unit is rotated about the respective axis of rotation via the drive unit.

A plasma beam is understood to be a beam of a reactive medium that also comprises ionized atoms or molecules in addition to neutral, excited atoms or molecules, respectively. The excited or, respectively, ionized particles induce a strong interaction on the surface to be treated, this leading to a surface pretreatment. In accordance with the invention the plasma beam is preferably generated via an arc discharge between at least two electrodes of the nozzle unit.

The plasma beam is thereby preferably transferred to the surface without transfer of discharge sparks, i.e. potential-free, in order to achieve a selective plasma treatment of the surface. If a combined treatment is desired where both the plasma beam and discharge sparks are brought into interaction with the surface, this can be provided by a corresponding configuration or operating mode of the nozzle unit. This combined effect of plasma beam and discharge sparks on the surface to be treated may thus also be acceptable, even if it is less desired than a pure plasma radiation, in order to form the nozzle unit with small dimensions in such a way that inaccessible regions of the inner surface can also be treated. In other words a potential can thus be transferred with the radiation, as required, if this is desired or acceptable for other reasons.

The term arc discharge is to be understood phenomenologically within the scope of the present application as an arc of light. This means that the voltage applied to the electrodes for plasma generation is not a continuous direct voltage.

Instead, the plasma is generated by a high-frequency voltage, in particular by a high-frequency alternating voltage. However, since the frequency of the excited voltage is selected to be so high that an observer, by way of luminous phenomena, cannot visually ascertain any difference to discharges generated by continuous direct voltages, reference is simply made to an arc discharge in the present application.

A high-frequency voltage applied to the electrodes of the nozzle unit in order to generate the plasma beam is, for example, understood to be an alternating voltage with alternating polarisation or a pulsed direct voltage with voltage levels of only one polarity, where the voltage levels alternate between two levels. In the end, a pulsed direct voltage is an alternating voltage superposed by a constant direct voltage portion. The frequency preferably lies within a range from 10 kHz to 100 kHz. However, deviations from this range are possible. The amplitude of the voltage, measured peak-to-peak, is thereby approximately 1 kV to 40 kV. However these values may also deviate in up or down direction.

When using the working gas in the nozzle unit, it is particularly expedient for the arm of the supply line for the working gas to be formed in such a way that no separate component is required to form the arm.

Within the scope of the present application, the term working gas for plasma generation includes suitable single-component gases, for example nitrogen, as well as multi-component gas mixtures, for example, air, forming gas, CO₂, acetylene/N₂ mixture or any other gas mixtures suitable for plasma generation.

Alternatively or additionally, it may be provided for the at least one nozzle unit to be used for satisfactory surface treatment with a distance of the gas outlet relative to the inner surface to be treated of less than 30 mm, preferably less than 20 mm, in particular less than 10 mm. Inner surfaces in dimensionally narrow regions can then also be optimally treated with the plasma beam. In addition, the distance to the respective inner surface to be treated is kept constant, preferably during a complete rotation about the axis of rotation. In other words the axis of rotation is preferably oriented concentrically to a center line of the recess forming the inner surface. In particular, this is suitable in conjunction with the treatment of rotationally symmetrical bores, such as cylinder bores in a motor unit.

In order to use the device to treat comparatively narrow recesses, such as the inner faces of a cylinder in an internal combustion engine, for example for a car, it is preferred if the dimensions of the device, in particular of the nozzle unit, are not too large. In any case the nozzle unit must still fit inside the opening of the workpiece and also still be rotatable there. In a further configuration the nozzle unit consequently comprises a maximum expansion of approximately 80 mm, preferably 40 mm in a direction perpendicular to the axis of rotation. It is further preferred for the maximum dimension of the nozzle unit, irrespective of in which direction, to be at most 80 mm, preferably 40 mm. It is thus ensured that cylinders or the like having an inner diameter with a minimum value down to 90 mm, in particular down to 50 mm, can be readily treated with the plasma beam. The at least one nozzle unit further preferably enables treatment of the respective surface over a wide region of the treatment distance between the gas outlet and the surface to be treated, in such a way that a cylinder or the like having an inner diameter of approximately 150 mm, preferably approximately 250 mm can, nevertheless, also be treated without making any changes to the device.

In a further configuration of the device it is provided for the maximum expansion of the nozzle unit, in a direction perpendicular to the axis of rotation, to be greater than the distance between the gas outlet of the nozzle unit and the axis of rotation in a direction perpendicular to the axis of rotation. The aforementioned maximum dimension is preferably approximately twice as large as the aforementioned distance from the axis of rotation. The nozzle unit can thus also still be placed in particularly small openings of the workpiece relative to the dimensions of the nozzle unit. The nozzle unit is thus preferably of approximately the same dimension in the direction of the gas outlet and in the opposite direction, in each case relative to the axis of rotation.

In a constructionally simple configuration is it provided for the gas inlet and the gas outlet of the at least one nozzle unit to lie on a line that substantially coincides with the preferential direction. The plasma radiation can therefore be used as energy efficiently as possible.

Alternatively or additionally, at least one supply device for at least indirectly supplying a working material, in particular a coating material or precursor material, to the nozzle interior of the at least one nozzle unit is provided in accordance with the device or in accordance with the method. Different types of treatment of the surface of the workpiece are thus made possible. At least one material can be supplied to the working gas and/or the plasma beam using the supply device. The supply may thereby be active, for example by injection, or passive, for example by using a capillary effect and evaporation. The at least one material may be in the solid, liquid and/or gaseous state during the supply process. Materials that can be taken into consideration include those that are suitable for coating or plasma polymerisation. For example, it may be a precursor material, i.e. a multi-component material, in which the plurality of components only combine with one another in the plasma beam to form the actual desired material, for example a product of a chemical reaction. A further application may be that water vapour is added to the nozzle unit, the water of the vapour being converted into oxygen and hydrogen in the plasma beam.

The at least one supply device can be arranged at the device for generating a plasma beam in such a way that the supply of the at least one material takes place in the region of the gas inlet. However, the supply may also take place in the region in which the arc discharge manifests. It is also possible for the supply to be made in the region of the gas outlet or else outside the housing.

It is decisive for the at least one material to come into contact with the plasma beam.

In a further configuration it can be provided for at least two nozzle units, each with a nozzle interior, to be provided. A larger surface can thus be treated in the same period of time available or a given surface can be treated more intensively.

In this regard the at least two nozzle units can each comprise a gas outlet for the outflow of the plasma beam from the nozzle interior, the plasma beams flowing out from the gas outlets all having a different preferential direction. In this instance different regions of the surface of the workpiece are each treated at a specific moment by the nozzle units provided.

However, in particular when using two nozzle units, the preferential directions of the plasma beams can be oriented parallel to one another. This leads to a virtual widening of the plasma beam if the plasma beams emitted from the gas outlets to the same side. In an alternative configuration the preferential directions, in particular of two nozzle units, are also oriented parallel but on opposite sides. A front and rear region of the surface, for example in a bore in the workpiece, can thus always be treated simultaneously.

The nozzle unit for generating a plasma beam is preferably substantially in the form of a hollow cylinder. In this configuration the at least two electrodes transverse to the direction of flow of the working gas can be integrated into the side wall of the housing diametrically spaced apart from one another. Furthermore, the gas inlet and the gas outlet can be arranged spaced apart from one another at the opposite end faces of the hollow cylinder.

In a further configuration of the device for generating a plasma beam, the device comprises at least one power supply that is connected to the at least two electrodes. Power supplies with which a high-frequency voltage, in particular a high-frequency alternating voltage can be generated are particularly preferred.

High-frequency voltages, in particular high-frequency alternating voltages are preferably used in the generation of a non-thermal plasma. Since the value of the voltage amplitude with a high-frequency voltage falls below a specific value required for discharge generation at regular time intervals, the discharge ceases until the value of the voltage amplitude subsequently again exceeds the specific value necessary for discharge generation and thus forms a discharge again. This regular ignition and ceasing of the discharge has the effect that only a small part of the energy involved with the discharge can be converted into heat. The rise in temperature of the working gas and also of the plasma is thus limited. The high-frequency voltage can thus also be configured as an alternating voltage superposed with a constant direct voltage up to a pulsed direct voltage. However, an essential feature of the high-frequency voltage is the high frequency and not the polarity of the voltage levels.

A plasma beam that is generated by the devices and methods described above can, for example, be used when removing the coating of surfaces of a workpiece. For example a layer of organic material, for example a coat of lacquer, can be removed from a surface of a workpiece using a plasma beam of this type. The organic substance is pyrolysed and/or sublimated, preferably at low temperatures. However, it is also possible for inorganic layers to be removed using a plasma beam of this type.

In addition, a plasma beam that is generated by the devices and methods described above can also be used for pretreatment of the surfaces of workpieces. For example, the adhesive properties and/or the wettability of the surface of a workpiece can be improved, in particular the surface can be activated. The pretreatment with a plasma beam of this type can also be used to improve the weldability of a workpiece, in particular of a metal piece or metal alloy piece provided with an oxide layer/hydroxide layer.

In an alternative configuration of the teaching, the generated radiation is an ionized radiation, preferably a corona discharge that is understood as radiation within the meaning of the invention. It is assumed that the radiation from the generating unit is directed toward the surface to be treated, namely in a preferential direction. The generating unit thereby comprises at least one electrode that is preferably impinged by an alternating voltage. If required, this at least one electrode can interact with the workpiece as counter electrode, which in particular is earthed. In any case, however, a corona discharge is also generated in the intermediate space between the generating unit and the surface to be treated of the workpiece. The intermediate space preferably has a small width, for example of less than 5 mm, in particular less than 3 mm.

The preferential direction can be viewed differently, depending on whether the corona discharge radiates homogeneously with regard to its direction, for example radiates from an even structure of the electrode, or for example radiates from a curved structure in different directions. In the first case there is a single, averaged preferential direction that is substantially identical to the directions of the radiation to be determined locally. In the second case the corona radiation is to be considered as a row of individual radiations, each with a preferential direction that is approximately representative, in particular averaged.

In conjunction with the preferential direction, it should be taken into account when using a corona discharge to generate an ionized radiation, in contrast to the use of a plasma radiation, that the preferential direction represents a theoretical direction that however readily results from the shape of the electrode and the configuration of the generating unit as the intended direction of the corona discharge for the person skilled in the art. The current direction is thereby insignificant and the preferential direction for a positive corona or a negative corona is always defined from the electrode to the surface to be treated.

Thus it is taken account of the situation that the direction of the corona discharge or, respectively, of the ionized radiation in practical application depends not only on the device used, but also on the configuration of the surface to be cleaned relative to the respective electrode. The features of the device should be assessed by the definition of the preferential direction, but irrespectively of the practical use.

When using a generating unit generating a corona discharge, this unit, in particular at least one electrode thereof, is brought to a short distance from the surface to be treated, very short treatment distances between the at least one electrode and the surface being relatively uncritical. In contrast, the maximum treatment distance is highly dependent on the operating parameters of the device, in particular on field strength and therefore on the voltage and frequency applied to the at least one electrode. In principle, variations in the dimension of the workpiece are considerably more critical for devices with a given generating unit for generating a corona discharge than for devices with a nozzle unit. When using corona discharge greater attention should also be paid to ensure that the treatment distance does not deviate too strongly during a complete rotation.

The at least one electrode can be rod-shaped, cylindrical, tubular, disc-shaped or annular for optimal adaptation to the inner surface of the workpiece to be treated.

In order to achieve greater surface treatment of the inner surface to be treated of the workpiece, the number of electrodes used can be increased and/or at least one electrode can be used that comprises a plurality of separate generating portions for generating a corona discharge. Corona discharges can thus emanate from at least two different points of an electrode and be directed toward the inner surface of the workpiece, the generating portions preferably projecting relative to the adjacent portions of the electrode or comprising a deviant insulation, in such a way that the generating portions are particularly suitable for forming corona discharges.

Thereby, the at least two generating portions can optionally be arranged distributed over the periphery and/or over the length of the at least one electrode. In the case of rod-shaped electrodes, the distribution along the length of the electrode is particularly expedient, whilst in the case of disc-shaped, annular, tubular and/or cylindrical electrodes, the distribution of the generating portions along the periphery is particularly advantageous.

In this regard a star-shaped electrode can also be provided, it being possible for corona discharges to be formed at its star-shaped ends. Since the star-shaped electrode rotates during surface treatment, uniform treatment of the surface distributed over the periphery can still be achieved.

A working material of the aforementioned type can also be supplied when using a generating unit for generating a corona discharge, the working material then being placed in the intermediate space between the generating unit, in particular the at least one electrode, and the surface of the workpiece.

In a further configuration it can be provided for at least one generating unit for generating a corona discharge to be provided with at least two electrodes. A larger surface can thus be treated in the same period of time available or a given surface can be treated more intensively. Ionized radiation can then be emitted from the two electrodes, each in another preferential direction, both preferential directions preferably being inclined relative to the axis of rotation of the generating unit comprising the at least two electrodes.

For example, two rod-shaped electrodes can be arranged at equal distances from the axis of rotation and also preferably distributed uniformly over the periphery of a virtual cylinder arranged concentrically with the axis of rotation. When treating a concentric bore, both electrodes are thus at the same distance from the surface and each electrode leads to a treatment of another part of the inner surface. Alternatively however, the electrodes can also be cylindrical, tubular or annular. A corona discharge, preferably directed toward the surface of the workpiece surrounding the electrode over the entire periphery of the electrode, or, respectively, a radiation with preferential directions distributed over the entire periphery or, respectively, over 360° is thus provided.

In a further preferred configuration of the device for generating a corona discharge, the device comprises at least one power supply that applies a high voltage in the form of an alternating voltage to the at least one electrode. The requirements placed on this power supply are given in a per se known manner in each individual case.

A further possible application of the devices described above is the cleaning, disinfection or else sterilization of surfaces, either using the corona discharge or the plasma beam. By the application of a plasma beam or corona discharge of this type a reactive medium, for example a high-energy radiation, is brought into contact with the surface. As a reactive medium, the plasma exhibits a high reactivity owing to high electron excitation, but despite this can also have a non-thermal property. For example, the high reactivity can be used to clean or else to disinfect the surface. During treatment with a plasma beam the germs present on the surface to be processed are killed off, at least in part and preferably predominantly, as a result of the reactivity of the electrons. If the plasma has a non-thermal property, the thermal loading of the surface is kept low at the same time. Applications for the plasma beam, for example in the medical or food industries, are thus made possible.

### BRIEF DESCRIPTION OF THE DRAWINGS

The invention will be described hereinafter with reference to drawings that merely show embodiments and in which:

FIG. 1 is a schematic sectional view of a nozzle unit of a first embodiment of the device according to the invention;

FIG. 2 is a schematic sectional view of a nozzle unit of a second embodiment of the device according to the invention;

FIG. 3 is a schematic sectional view of a third embodiment of the device according to the invention with use of a nozzle unit;

FIG. 4 is a schematic plan view of a fourth embodiment of the device according to the invention with use of a nozzle unit;

FIG. 5 is a schematic side view of a fifth embodiment of the device according to the invention with use of two electrodes to generate a corona discharge;

FIG. 6 is a schematic sectional view of the embodiment from FIG. 5 along the plane VI-VI from FIG. 5;

FIG. 7 is a schematic side view of a sixth embodiment of the device according to the invention with use of an electrode to generate a corona discharge;

FIG. 8 is a schematic sectional view of the embodiment from FIG. 5 along the plane VIII-VIII from FIG. 5, and

FIG. 9 is a schematic plan view from above of a sixth embodiment of the device according to the invention with use of an electrode to generate a corona discharge.

### DESCRIPTION

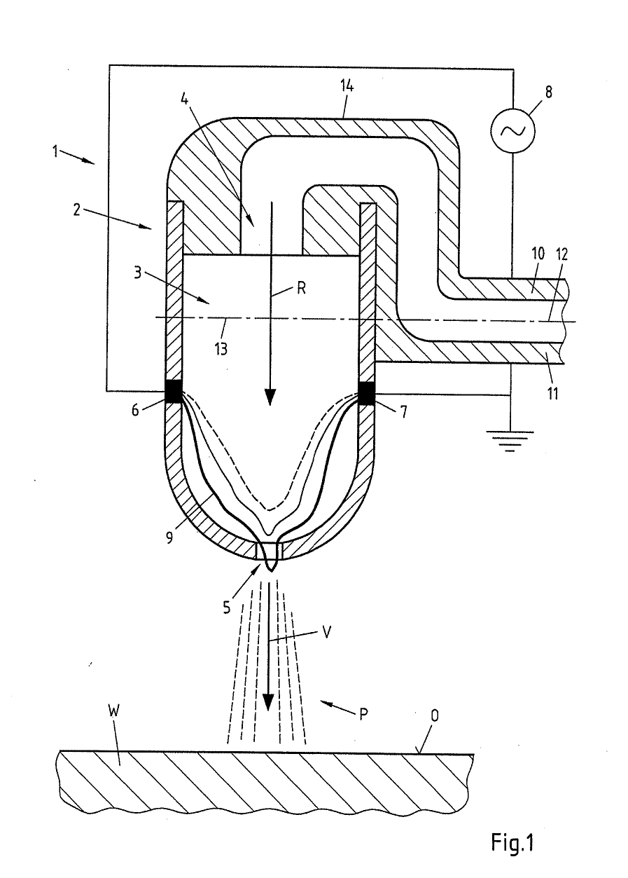

FIG. 1 is a schematic view of a part of a first embodiment of the device 1 according to the invention for treating a workpiece surface O with a plasma beam P. In the detail shown in FIG. 1 a nozzle unit 2 is illustrated that surrounds a nozzle interior 3. A gas inlet 4 is arranged at one end of the nozzle unit and a gas outlet 5 is arranged at the opposite end. The flow cross-section of the gas inlet 4 is narrowed compared to the flow cross-section of the nozzle interior 3. In this example the gas outlet 5 is formed in one piece with the nozzle unit 2 by a central circular bore in the end face of the nozzle unit 2 remote from the gas inlet 4. In the region of the side wall of the nozzle unit 2 between the gas inlet 4 and the gas outlet 5, two electrodes 6, 7 associated with the nozzle interior 3 are provided diametrically spaced apart from one another.

The two electrodes 6, 7 are electrically connected to a power supply 8, with which a high-frequency voltage, in particular a high-frequency alternating voltage can be generated. The flow cross-section of the nozzle interior 3 tapers from the region in which the two electrodes 6, 7 are arranged, as far as to the region of the gas outlet 5 in that the side wall of the nozzle unit 2 is curved in this portion. The flow cross-section in the gas outlet 5 is also reduced compared to the flow cross-section in the gas inlet 4.

During operation of the nozzle unit shown in FIG. 1, a working gas, for example air, is introduced through the gas inlet 4 into the nozzle unit 2, flows through the nozzle interior 3 largely parallel to the central axis thereof and then exits, in a focussed manner, through the gas outlet 5 in a preferential direction V, also parallel to the central axis of the nozzle interior 3.

A high-frequency electric voltage is applied between the two electrodes 6, 7 by the power supply 8, in particular the frequency having approximate values in the order of 1 kHz to 100 kHz, whilst the voltage levels, measured peak-to-peak, are in the order of approximately 0.5 kV to 30 kV. The voltage ensures that a “light arc” 9 is formed in the working gas between the electrodes 6, 7, along which arc the working gas is ionized, at least in part, and is therefore excited to form a plasma. As a result of the flow of the working gas along the direction of flow R through the nozzle unit 2, the ionized part of the working gas that exhibits the lowest electrical resistance in the working gas is deformed in the direction of the gas outlet 5 in such a way that a correspondingly deformed “light arc” 9 is formed.

The plasma formed along the “light arc” 9 is then led through, in a beam-like manner, out of the gas outlet 5 in the preferential direction V by the flow of the working gas, i.e. as an aligned and bundled plasma beam P. As can be seen from this illustration, the current-carrying “light arc” 9 and the potential-free plasma beam P are thus separated. Direct impingement of the surface O by the “light arc” 9 can thus be avoided during surface treatment.

The preferential direction V practically represents a flow direction averaged by the flow cross-section at the gas outlet 5, since the plasma beam P naturally widens after the gas outlet and therefore comprises locally different flow direction components.

Alternatively, a total of four electrodes could also be integrated into the side wall of the nozzle unit 2. Two electrodes diametrically spaced apart from one another thus form an electrode pair in each case. The electrode pairs are arranged in such a way that the connection lines between the electrode pairs extend perpendicular to one another. Furthermore, two independent, in particular in-phase power supplies are provided that are each electrically connected to an electrode pair.

The nozzle unit 2 shown in FIG. 1 is mounted at an arm 10 that is narrow compared to the nozzle unit 2. In the embodiment illustrated the arm 10 simultaneously corresponds to the supply line 11 for working gas to the nozzle interior 3. The arm 10 can be rotated about its axis of rotation 12 by a drive device (not shown in FIG. 1), said axis of rotation corresponding to the central axis of the supply line 11. Since the arm 10 is rigidly connected to the nozzle unit 2, the rotation of the arm 10 leads to rotation of the nozzle unit 2 about an axis of rotation 13 identical to the axis of rotation 12. The preferential direction V of the plasma beam P flowing out from the gas outlet 5 is thereby oriented substantially at right angles to the axis of rotation 13 of the nozzle unit 2.

As a result of the configuration of the arm 10, the nozzle unit 2 can also be placed readily in small openings of the workpiece W in order to treat there the inner surface O of the workpiece W with the plasma beam P. The nozzle unit 2 is rotated about the axis of rotation 13 in such a way that the inner surface O can be treated in a circular manner with the plasma beam P. The workpiece W indicated merely in FIG. 1 is an internal combustion engine of a car, the nozzle unit 2 being inserted into a cylinder of the internal combustion engine. The inner surface O of the cylinder is thus treated in a circular manner by the plasma beam P. Whilst the nozzle unit 2 rotates about the axis of rotation 13, the nozzle unit 2 moves along the entire depth of the cylinder via the arm 10 so said cylinder can be treated along its entire depth by the plasma beam.

In the embodiment shown, the arm 10 is connected to the nozzle unit 2, approximately centrally to the longitudinal extension of the nozzle unit 2, the supply channel 11 for the working gas therefore being guided around the nozzle interior 3 in a U-shaped manner. The expansion of the nozzle unit 2 in the drawing plane from the axis of rotation 13 as far as the gas outlet 5 is therefore approximately as large as the expansion of the nozzle unit 2 from the axis of rotation 13 to the rear end 14 of the nozzle unit 2 remote from the gas outlet 5. The distance from the gas outlet 5 to the rear end 14 of the nozzle unit 2 measures approximately 40 mm in the nozzle unit 2 shown. The nozzle unit 2 is also configured in such a way that the treatment of the inner surface O of the workpiece W can be readily carried out at a treatment distance of less than 20 mm. By using the device 1 shown in FIG. 1, cylinders with an inner diameter of down to 50 mm can be treated readily.

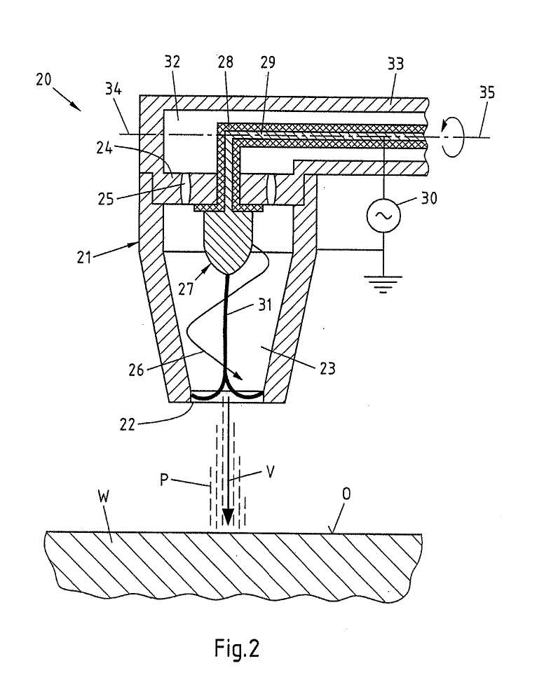

The nozzle unit 20 shown in FIG. 2 comprises a nozzle tube 21 made of metal that tapers conically toward a gas outlet 22 and encloses a nozzle interior 23. An end wall 24 of the nozzle interior 23 comprises a crown of gas inlets 25 arranged inclined in the peripheral direction in order to swirl the working gas. The working gas therefore flows through the nozzle interior 23 in the form of a vortex 26, the core of which extends along the longitudinal axis of the nozzle interior 23.

An electrode 27 projects centrally from the end wall 24 and coaxially into the nozzle interior 23. The electrode 27 is electrically insulated against the other parts of the nozzle unit 20 by an insulator 28. A high-frequency alternating voltage generated by a high-frequency transformer 30 is applied to the electrode 27 via an insulated shaft 29.

The voltage is variably controllable and, for example, is 500 V or more, preferably 2-5 kV, in particular more than 5 kV. For example, the frequency is in the order of 0.5 kHz to 50 kHz, preferably in the range from 15 to 30 kHz, and is preferably also adjustable. The properties of the plasma can be influenced by selective variation of the frequency and/or the amplitude of the voltage.

A high-frequency discharge in the form of an arc discharge 31 is generated by the voltage applied. As a result of the swirling flow of the working gas, the “light arc” 31 in the vortex core is channelled over the central axis of the nozzle unit 20 in such a way that the “light arc” 31 is branched at the gas outlet 22 and ends there. The working gas that rotates in the region of the vortex core and therefore rotates in the direct vicinity of the “light arc” 31 at high flow velocity contacts the “light arc” intimately and is thus converted, in part, into the plasma state in such a way that a plasma beam P of a comparatively cool atmospheric plasma is emitted from the gas outlet in a preferential direction V. The preferential direction V is thereby directed approximately at right angles toward the surface O to be treated of the workpiece W.

A channel 32 for supplying working gas to the nozzle interior 23, which extends approximately at right angles to the preferential direction V of the emitted plasma, connects to the side of the end face 24 remote from the nozzle interior 23. The electrically conducting shaft 29 connected to the electrode is guided centrally along this channel 32. The channel therefore ultimately forms an arm 33 to which the nozzle unit 20 is fixed and at which the nozzle unit 20 also can be dipped into an opening, such as a bore in a workpiece in order to process the inner surface of the workpiece there using the plasma beam P. The bore or the like is treated over the entire periphery by the plasma beam P, in that the nozzle unit is rotated about an axis of rotation 34 that is oriented substantially perpendicularly to the preferential direction V of the plasma beam P emitted from the gas outlet 22. The axis of rotation 34 is thereby defined by the center line of the arm 33, which is rotated by a drive unit leading to a rotation of the nozzle unit 20 as a result of the rigid connection between the arm 33 and the nozzle unit 20. The axis of rotation 34 of the nozzle unit 20 and the axis of rotation 35 of the arm 33 are consequently identical in the embodiment shown.

As a result of the connection of the channel 32 to the rear end of the nozzle unit 20, the minimum inner diameter of a bore that can still be processed using the nozzle unit 20 shown in FIG. 2 corresponds to approximately double the length of the nozzle unit 20 in the drawing plane plus double the minimum processing distance to the surface of the workpiece.

In both the nozzle units 2, 20 shown in FIG. 1 and in FIG. 2, a working material, for example in the form of a coating material, can be supplied to the working gas via a supply device (not shown in detail). The processing material is then intimately contacted with the working gas in the nozzle interior 3, 23.

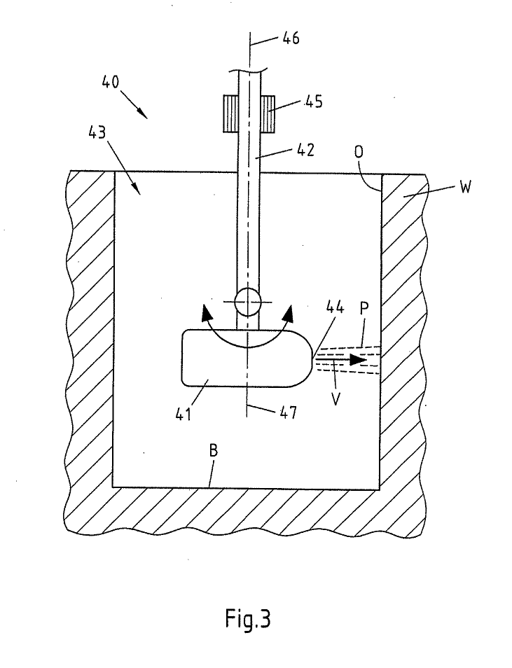

FIG. 3 shows a further embodiment of the device 40 for treating an inner surface O with a plasma beam P. The nozzle unit 41, illustrated merely schematically, may be a nozzle unit according to the operating principle illustrated in FIG. 1 or FIG. 2. The nozzle unit 41 is lowered at a long arm 42 into a blind bore 43 and treats there the inner surface O provided there of the workpiece W using the plasma beam P. The plasma beam P is thereby emitted from a gas outlet 44 in a preferential direction V perpendicular to the surface O to be treated.

An electric drive unit 45 that rotates the arm 42 is provided at an end of the arm 42 remote from the nozzle unit 41, the axis of rotation 46 of the arm 42 and axis of rotation 47 of the nozzle unit 41 coinciding. However, it would alternatively be possible to associate the drive unit or a further drive unit directly with the nozzle unit 41 and for this to be rotated about an axis of rotation 47 independently of the connected arm 42.

In contrast to the devices 1 illustrated in FIGS. 1 and 2, the arm in the device 40 illustrated in FIG. 3 is connected to the nozzle unit 41 in a jointed manner. The angle of the nozzle unit 41 to the arm 42 and therefore also the angle of the preferential direction V of the plasma beam P flowing out to the axis of rotation 47 of the nozzle unit 41 can thus be adjusted if required. The adjustment range in the embodiment illustrated is approximately 0° to 90°. In addition, the angle can be automatically changed during operation of the device 40. For example the base region B of the blind bore 43 can therefore also be suitably treated.

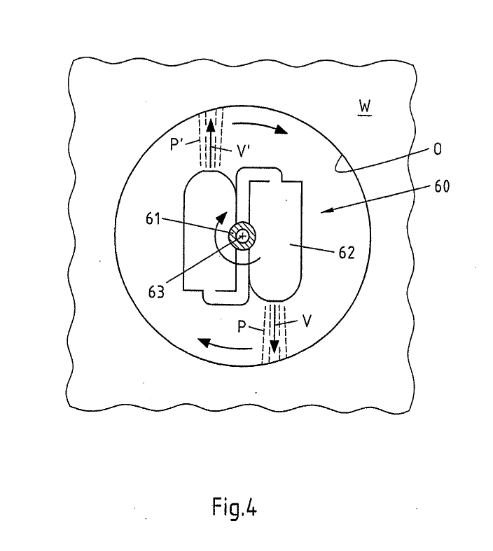

FIG. 4 shows a plan view from above onto a device 60 for treating an inner surface O of a workpiece W with a plasma beam P, P′, said device having been inserted at an arm 61 into a cylinder bore of a motor unit of an internal combustion engine. The arm 61 simultaneously constitutes the line for the supply of working gas to the two nozzle units 62 of the device. Two conductors for powering the electrodes of the two nozzle units are also guided along the arm 61, but are not shown in detail.

The nozzle units 62 are separate nozzle units 62, each comprising their own nozzle interior in which a plasma beam P, P′ emitted in a respective preferential direction V, V′ from the nozzle interior toward the inner surface O to be processed of the workpiece W is generated. For reasons of spatial requirements, the nozzle units 62, of which the operating principle may coincide with that of the nozzle units illustrated in FIGS. 1 and 2, may be arranged parallel to one another, the arm 61 engaging substantially centrally with this parallel arrangement of the nozzle units 62 and extending substantially along the center line of the cylinder.

The preferential directions V, V′ of the plasma beams P, P′ generated by the two nozzle units 62 are oriented parallel to one another and point in opposite directions. In the embodiment illustrated the preferential directions V, V′ of the plasma beams P, P′ of both nozzle units 62 are at right angles to the common axis of rotation 63 of the two nozzle units 62, which are rotated via the arm 61 by a drive unit (not shown in detail).

The cylinder bore thereby has a diameter of 60 mm, whilst each of the nozzle units in the drawing is no longer than 40 mm. A treatment distance of less than 10 mm is thus sufficient for treatment of the inner surface O of the cylinder bore.

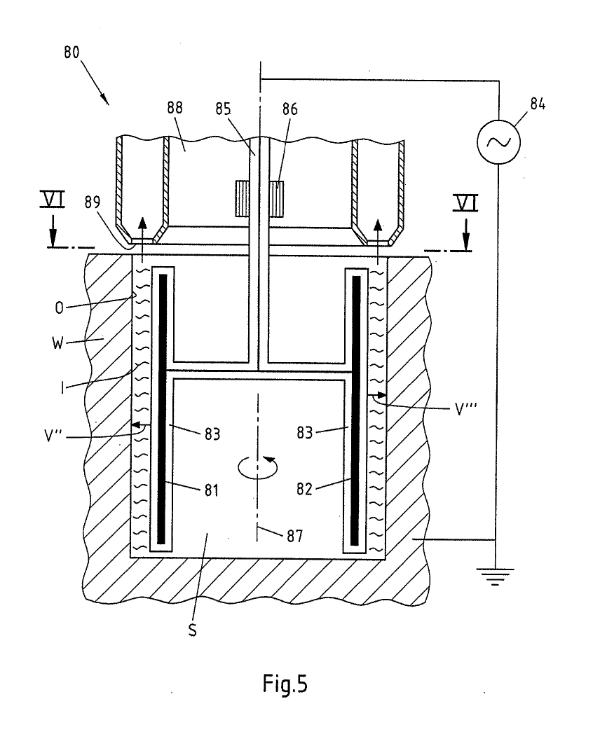

FIG. 5 shows a device 80 for treating the inner surface O of a workpiece W with ionized radiation I as a result of a corona discharge. The workpiece W comprises a blind bore S. For example it may be the cylinder head of an internal combustion engine. The bore could also be a through-bore, for example the workpiece constituting part of the motor unit and the bore being used to receive a cylinder.

In the embodiment illustrated, the device 80 comprises two interconnected electrodes 81, 82 that are arranged in the vicinity of the inner surface O to be treated of the workpiece W. The two electrodes 81, 82 are surrounded by electric insulation 83 and connected to a power supply 84 that provides a sufficiently high alternating voltage in such a way that a corona discharge is formed between the electrodes 81, 82 and the surface O to be treated and is referred to as ionized radiation I. In each case the ionized radiation I comprises a preferential direction V″, V′″ that points from the electrodes 81, 82 in a radial direction toward the inner surface O to be treated of the earthed workpiece W and is oriented at right angles to the inner surface O. In the arrangement illustrated the preferential directions of the two electrodes 81, 82 lie on a common line. This may also be different in another electrode arrangement.

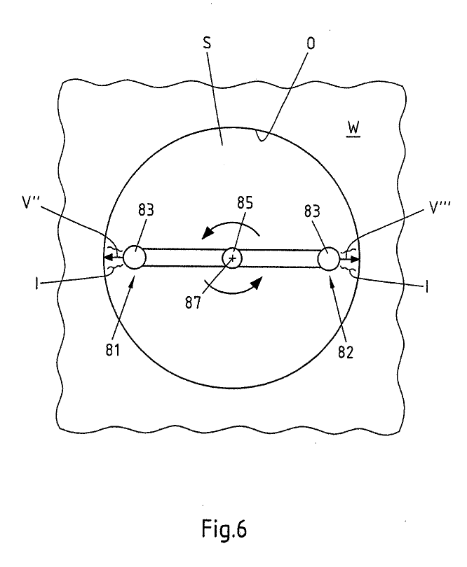

In the embodiment illustrated the power supply 84 of the electrodes 81, 82 takes place via an arm 85, which makes it possible to insert the electrodes 81, 82 into the workpiece W. A drive unit 86 is associated with this arm 85 and rotates the arm 85 about an axis of rotation 87 that extends through the longitudinal axis of the arm 85 in such a way that the electrodes 81, 82 move along the inner, peripheral surface O of the blind bore S, as is shown in particular in FIG. 6 in plan view. In the embodiment illustrated the electrodes are rod-shaped and extend substantially over the entire depth of the blind bore S. This enables rapid surface treatment.

A displacement means that makes it possible to introduce the electrodes 81, 82 into the blind bore S and to subsequently remove the electrodes 81, 82 from the blind bore S, in each case parallel to the longitudinal extension of the arm 85, is not shown in detail.

In the embodiment illustrated a suction means 88 is also provided above the electrodes 81, 82 and outside the opening of the blind bore S for sucking off the atmosphere in the gap between the electrodes 81, 82 and the surface O to be treated and therefore for sucking off any residual material removed from the surface O. The suction means 88 can also be dipped into the workpiece W. The suction means 88 has a suction opening 89 extending annularly in such a way that the suction means 88 does not have to be entrained in rotation with the electrodes 81, 82. However, this is also conceivable.

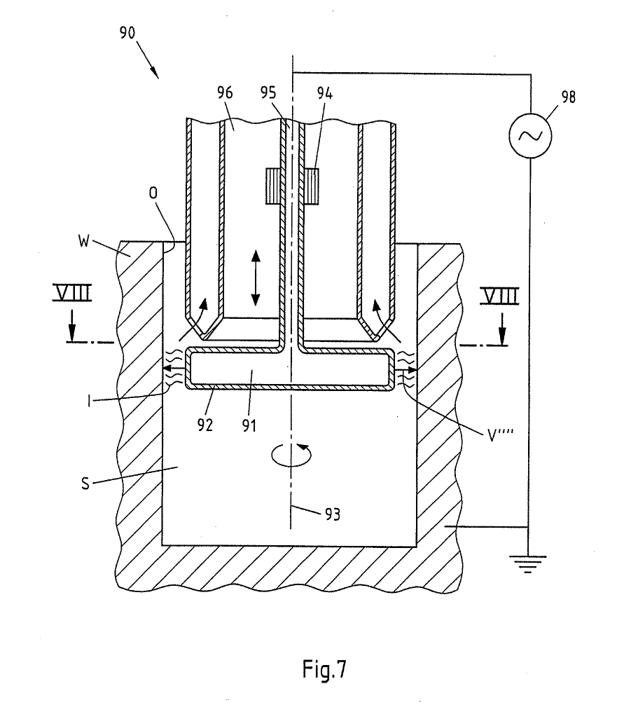

In the device 90 for surface treatment shown in FIG. 7, the generating unit comprises a disc-shaped electrode 91, of which the diameter is slightly smaller than the diameter of the blind bore S into which the electrode 91 is introduced. The electrode 91 comprises an insulation 92 that, together with the inner surface O, forms a substantially uniform gap having a width of a few millimetres. In order to achieve a uniform treatment of the inner surface O, the disc-shaped electrode 91 is rotated about an axis of rotation 93 that extends through the center point of the electrode 91, what for a drive means 94 acts on an arm 95 at which the electrode 91 is inserted into the blind bore S. The penetration depth of the disc-shaped electrode 91 during surface treatment can be varied by a displacement means (not shown in detail), which also preferably interacts with the arm 95, in order to reach all points of the inner surface O with the ionized radiation I. The ionized radiation I is directed perpendicularly onto the inner surface O of the workpiece W in radial preferential directions V″″.

In the embodiment illustrated a suction means 96 is also provided that, together with the electrode 91, is inserted into the blind bore and maintains a constant distance from the electrode 91. The suction means 96 also comprises a peripheral suction opening 97. However, in principle other suction openings can also be provided.

The power supply 98 of the embodiment shown in FIG. 7 does not differ from the power supply 84 of the embodiment shown in FIG. 5.

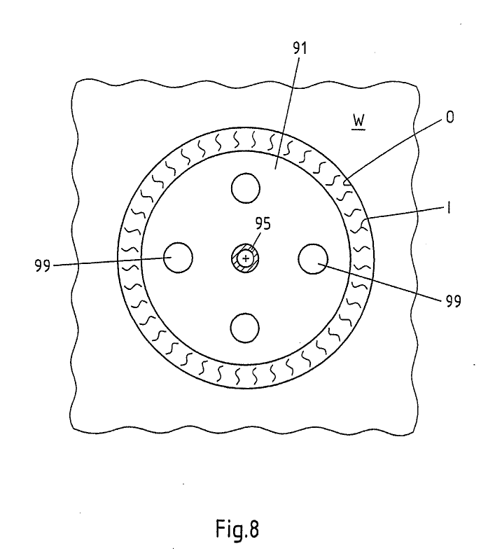

In FIG. 8 the disc-shaped electrode 91 is shown in plan view along the sectional plane VIII-VIII from FIG. 7, whereby a corona discharge is shown peripherally along the entire gap without individual discharge channels being indicated. The corona discharge can also be formed in the gap merely over portions thereof, the portions in which a corona discharge occurs changing in rapid alternation.

In the embodiment illustrated four through-openings 99 are provided in the disc-shaped electrode 91, through which openings the air or another gas or, respectively, gas mixture can flow into the blind bore S and is then sucked off again via the suction means 96 from the gap between the insulation 92 of the electrode 91 and the inner surface O of the blind bore S. A continuous air flow or the like can thus be maintained.

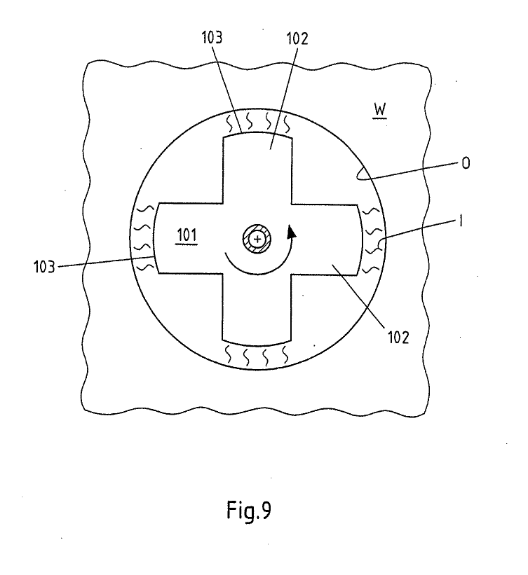

FIG. 9 shows an alternative to the disc-shaped electrode 101. It is star-shaped with four free ends 102. However, considerably more free ends of the star-shaped electrode can also be provided. During operation a corona discharge is selectively formed at each of the generating portions 103 provided at the free ends 102, in such a way that selective surface treatment can be carried out if applicable. In the case of the star-shaped electrode 101, it is also possible to dispense with through-bores for the flowing of air or another gas or, respectively, gas mixture.

1. A device for cleaning an inner surface of a workpiece,
with a radiation, with at least one generating unit for generating the radiation,
with a drive unit for rotating the at least one generating unit about an axis of rotation,
the at least one generating unit for emitting the generated radiation being configured with a preferential direction toward the surface to be treated,
wherein
an arm connected to the at least one generating unit is provided for inserting the at least one generating unit into the workpiece, and
the axis of rotation and the preferential direction are inclined relative to one another.

2. The device according to claim 1, wherein the axis of rotation and the preferential direction are arranged at an angle between 25° and 90° to one another.

3. The device according to claim 1, wherein a suction means is provided for sucking off a gas from a space between an electrode and the inner surface.

4. The device according to claim 1, for cleaning the inner surface of the workpiece with a plasma beam,
wherein
the at least one generating unit is at least one nozzle unit forming a nozzle interior,
the drive unit is provided for rotating the at least one nozzle unit about an axis of rotation,
the at least one nozzle unit comprises a gas inlet for the inflow of a working gas into the nozzle interior, and
the at least one nozzle unit comprises a gas outlet for the outlet of the working gas from the nozzle interior in the preferential direction.

5. The device according to claim 4, wherein the nozzle unit has a maximum dimension of approximately 40 mm in a direction perpendicular to the axis of rotation.

6. The device according to claim 4, wherein at least one supply device is provided for at least indirect supply of a working material to the plasma beam.

7. The device according to claim 4, wherein
at least two nozzle units are provided, each comprising a nozzle interior,
the at least two nozzle units each comprise a gas outlet for the emission of the plasma beam from the nozzle interior in a respective preferential direction, and
the preferential directions of the at least two nozzle units are arranged substantially parallel to one another.

8. The device according to claim 1, wherein
the radiation is an ionized radiation,
the generating unit comprises at least one electrode connected to a power supply and provided for generating a corona discharge in a space between the generating unit and the surface.

9. A method for cleaning an inner surface of a workpiece with a radiation, the method comprising:
inserting at least one generating unit connected to an arm into the workpiece at the arm,
rotating the at least one generating unit by a drive unit about an axis of rotation (13, 34, 47, 63, 87, 93), and
emitting the radiation by the at least one generating unit onto the surface in a preferential direction inclined relative to the axis of rotation.

10. The method according to claim 9 for cleaning an inner surface of a workpiece with a plasma beam,
wherein the at least one generating unit comprises at least one nozzle unit and forms a nozzle interior,
wherein the at least one nozzle unit is rotated by the drive unit about the axis of rotation,
wherein a working gas flows into the nozzle interior via a gas inlet, and
wherein the working gas flows out from a gas outlet in a preferential direction inclined relative to the axis of rotation.

11. The method according to claim 10, wherein the at least one nozzle unit is rotated about the axis of rotation oriented at an angle between 25° and 90° to the preferential direction (V, V′).

12. The method according to claim 10, wherein the inner surface of a bore with a diameter of less than 150 mm is treated with the plasma beam.

13. The method according to claim 10, wherein a working material is supplied at least indirectly to the plasma beam via at least one supply device.

14. The method according claim 10, wherein at least two nozzle units, each comprising a nozzle interior, are rotated about the axis of rotation, and
wherein plasma beams are emitted from the at least two nozzle units with parallel preferential directions (V, V′).

15. The method according to claim 9, wherein the generating unit comprising at least one electrode connected to a power supply generates a corona discharge in a space between the generating unit and the surface.

16. The device according to claim 1, wherein the axis of rotation and the preferential direction are arranged at substantially at right angles, to one another.
